(19) United States
(12) Patent Application Publication
(10) Pub. No.: US 2016/0042643 A1
(43) Pub. Date: Feb. 11, 2016

(54) Method for Displaying Parking Spaces

(71) Applicant: CLEVERCITI SYSTEMS GMBH, Starnberg (DE)

(72) Inventor: Thomas Hohenacker, Starnberg (DE)

(73) Assignee: Cleverciti Systems GmbH, Starnberg (DE)

(21) Appl. No.: 14/776,582

(22) PCT Filed: Mar. 12, 2014
(86) PCT No.: PCT/EP2014/054856

§ 371 Date: Sep. 14, 2015

(30) Foreign Application Priority Data
Mar. 14, 2013 (DE) 10 2013 004 493.6

(51) Int. Cl. G08G 1/14; G06Q 50/30

(52) U.S. Cl. CPC G08G 1/141; G06Q 50/30

(57) ABSTRACT

The invention relates to a method for displaying free and preferably also occupied parking space regions on a display device, wherein at least one camera supplies image indications of parking space regions. The geographic coordinates of a car park area located in the visual range of the camera are stored in a recognition unit. On the basis of the image indications, the recognition unit assigns each of the parking space regions inside the car park area a respective occupation status that indicates whether a respective parking space region is free or occupied. The recognition unit calculates the dimensions of a free parking space region at least in the longitudinal direction thereof (“size value”) from the supplied image indications. The recognition unit provides the respective occupation status of at least the free parking space regions along with the associated geographical coordinates to a transmission unit, and the transmission unit transmits the respective occupation status of at least the free parking space regions along with the associated geographic coordinates and the associated calculated size values to the display device. The invention further relates to a system comprising at least a camera, a recognition unit, a transmission unit and a display device, as well as to a data carrier having a computer program that can be executed on a recognition unit according to the invention. Finally the invention further relates to a recognition unit that can be used in accordance with the invention.

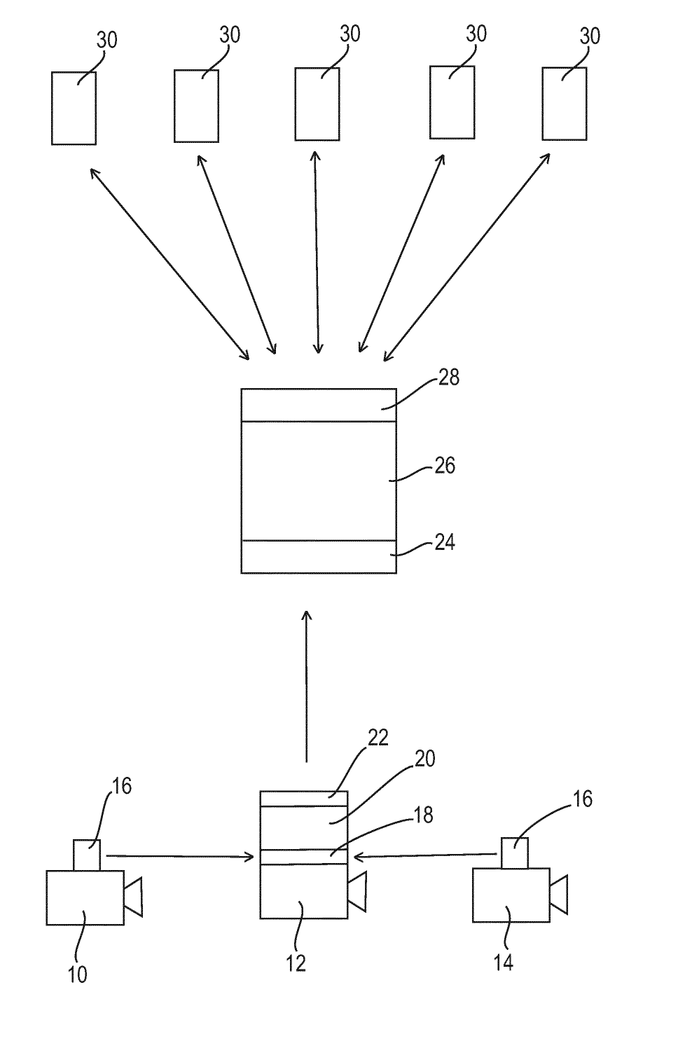

A high proportion of the traffic in city centers is caused by vehicles whose drivers are only searching for a parking space. In addition to an undesirably high time effort and equally undesirably high gasoline costs, this also results in disadvantageous environmental pollution due to the mentioned parking search traffic. The shortage of parking spaces in city centers thus has a negative effect both for the drivers of motor vehicles searching for a parking space and with respect to the environmental impact.

It is an object of the invention to provide a system for displaying parking spaces which allows an improved and, in the ideal case, an optimum utilization of the public parking spaces available in city center areas. It should in particular become possible in accordance with the invention to direct drives of motor vehicles searching for parking spaces by the shortest or fastest route to such free public parking spaces in city center areas which are also large enough for their respective vehicle.

This object is satisfied by a method in accordance with claim 1 and in particular by methods for displaying free, and preferably also occupied, parking space areas on a display unit, in which at least one camera, preferably a plurality of cameras, delivers/deliver image indications of parking space areas, wherein

the geographic coordinates of a parking space zone located in the visual range of the camera/cameras are stored in a recognition unit;

the recognition unit associates a respective occupation status with parking space areas disposed within the parking space zone in dependence on the image indications, said occupation status marking whether a respective parking space area is free or occupied;

the recognition unit calculates the dimensions of a free parking space area, at least in its longitudinal direction (“size value”), from the delivered image indications;

the recognition unit provides the respective occupation status of at least the free parking space areas with the associated geographic coordinates and the associated calculated size values to a transmission unit; and

the transmission unit transmits the respective occupation status of at least the free parking space areas with the associated geographic coordinates and the associated calculated size values to the display unit.

In accordance with the invention, free parking space areas within each parking space zone, preferably monitored by a single camera, are dynamically determined and are displayed, with the size values of free parking space areas being able to change depending on the current occupation status of the respective parking space zone. Such a change of the size values in particular occurs when the parking space zone is not divided into individual parking space areas by visible markings, that is e.g. when the parking space zone is formed by the non-used side strip of a street which does not have any markings separating the individual parking spaces from one another.

In accordance with the invention, however, size values of parking space areas can also be determined and displayed which are separated from adjacent parking space areas by markings or other suitable boundaries. This is e.g. of interest when the parking space zone is formed by a public or private parking space having a plurality of marked parking space areas which are at least partly adjacent to one another and which in particular have sizes differing from one another. It can also be taken into account in this variant in accordance with the invention if a vehicle is not parked in a correct manner such that it projects beyond the marking of a parking space area which is free in principle and projects into said parking space area and thus reduces its size. In this case, the size dimensions of the parking space area which is free in principle and which is reduced by the named vehicle can be determined and displayed.

Finally, however, the size dimensions of the respective free parking space areas are determined in accordance with the invention by an image analysis of the parking space zone and are displayed together with the occupation status “free” and the associated geographic coordinates.

When calculating or interpolating the size values, fixed reference values in the region of parking space areas such as ground markings, trees, masts, traffic signs, vending machines, buildings and other geographic markers are used whose exact geographic position is known or can be calculated and/or whose distances from one another are known or can be calculated.

The monitored parking space zone is preferably divided into mutually adjacent, rectangular part areas of respective equal size for which then an examination is carried out in each case by means of an image analysis whether a respective part area is completely free or is at least partly covered by a vehicle. A plurality of mutually adjacent completely free part areas then together form a free parking space area. The size of such a parking space area is then not determined continuously, but rather in a predefined size grid in which the smallest grid spacing corresponds to one of the named part areas. The part areas e.g. have side lengths between 10 and 100 cm, they are preferably square with a side length of approximately 20, 30, 40 or 50 cm.

The use of a camera with a swivel and twist head is particularly advantageous. The swiveling or twisting of the camera can in this respect take place about one axis or e.g. also about two axes standing perpendicular to one another. On the use of such a camera, the coordinates of the parking space areas can also be calculated via the inclusion of the internal angular degrees of the swivel and twist head.

The advantage of a system or of a method having a pivotable camera is also found in the fact that it is possible to analyze parking zones much more exactly with a camera with a highly-exact swivel and twist head (e.g. 0.0005 degrees of angular precision, with it being ensured that the camera cannot lose its position and reference), with a high resolution and/or with a zoom capability than with a static camera since considerably more pixels are available per parking space area than when using a static camera. If it is wanted to achieve a corresponding quality with static cameras, a plurality of static cameras would in every case have to be provided instead of a single pivotable camera.

A single pivotable camera with a swivel and twist head can consequently replace a number of single static cameras since they can e.g. easily deliver 20 to 30 camera perspectives or also any desired number of camera perspectives of a street representing a parking space zone in the sense of this application. It is equally possible to monitor a public or private parking space with up to 100 or more marked or unmarked parking space areas which at least partly adjoin one another using a single pivotable camera or only very few pivotable cameras.

When using a camera with a swivel and twist head, a side of a street of, for example, 200 m in length can e.g. be defined as a parking space zone having a plurality of parking space areas, with the start and the end of this parking space zone being known and stored in the form of its geographic data. The swivel and twist head can now zoom as much as desired into the taken image on a predefined, high-precision track curve along the street to carry out the best possible analysis of the parking space zone. The respective coordinates of the smaller, individual parking space areas are known by the reading out of the angular positions of the swivel and twist head. Individual coordinates of the total parking space zone, which do not have to be at the image center, can thus also be determined within an image. In a corresponding manner, a public or private parking space having a number of marked or unmarked parking space areas adjacent to one another at least in part can be monitored in that at least one camera with a swivel and twist head scans this parking space in accordance with an in turn predefined track curve.

Trees or other obstacles are generally excluded from the analysis, i.e. such regions are marked in advance and not analyzed. However, such regions can be used as immovable reference points with a known geographic position for calculating the position of parking space areas.

The object is furthermore satisfied by a system in accordance with claim 9 as well as by a data carrier with a computer program in accordance with claim 10 and by a recognition unit in accordance with claim 11.

The invention can in particular advantageously be used when the available public or private parking spaces are, for example, not divided into individual parking spaces by markings, parking meters or the like. In these cases, no single parking spaces of fixedly predefined sizes are namely available which are as a rule sufficient for normal passenger cars. The determination of size values of the free parking space areas which are available is particularly helpful here since it is thus already clear before driving to a free parking space area whether it is large enough for the respective vehicle.

However, the invention can also be sensibly used with parking spaces or parking space zones divided into individual parking spaces or parking space areas, in particular in those cases in which the individual parking spaces have sizes differing from one another or in which an individual parking space is reduced in size due to vehicles not correctly parked in adjacent individual parking spaces. In accordance with the invention, the respective actually available size dimensions of the free individual parking spaces can then be exactly determined.

It is in particular helpful for the management of occupied parking spaces and/or for automatic payment systems if the parking space areas are marked by a code in a regular pattern (e.g. every 2 m) and if the user of a parking space occupied by him reports the code closest to the center of his vehicle to a server which inter alia comprises the transmission unit in accordance with the invention. The occupied parking space area can then be recorded in a simple manner by the server. If the size of the occupied parking space area is also to be recorded, the camera can record the vehicle of a user in the geographic region of the communicated code. The size of the occupied parking space area can then be calculated from the detected image indications using suitable algorithms.

An internet-enabled mobile or stationary end device can preferably be used as the display unit. It is particularly preferred for the display unit to be configured as an internet-enabled cell phone or as an internet-enabled vehicle computer. A stationary computer or a display panel can, however, also equally be used.

The transmission unit can deliver the named data to a plurality of display units of different users to whom the locations can then respectively be displayed at which they can find free parking spaces.

The recognition unit can be fully or partly a component of a server which also comprises the transmission unit. In this case, the recognition unit, partly or in full, the transmission unit and the server are e.g. accommodated in a common housing or are arranged close to one another at a specific location. The recognition unit can, however, also equally be integrated completely or partly into the housing of the camera.

The use of a server comprising at least the transmission unit is in particular sensible when a plurality of cameras are used for monitoring a parking space zone respectively associated with it. In this case, the data of a plurality of parking space zones delivered by the individual cameras can be collected on the server and can be transmitted to the at least one display unit by means of the transmission unit of the server.

If only one camera is used within the framework of the invention for monitoring a specific parking space zone, it is also possible to accommodate the camera and the transmission unit in a common housing. This variant is sensible, for example, if a parking space zone located in front of a shopping center is to be monitored by means of a single camera and if the occupation status of the parking space areas is to be displayed at a display panel in the region of the entrance to the parking space zone.

It is particularly advantageous if the recognition unit is partly, but preferably fully, a component of the camera or if the recognition unit or at least a part of the recognition unit and the camera are arranged at a common location, in particular in a common housing. If the complete recognition unit is provided at the location of the camera, the complete processing of the image indications and/or images recorded by the camera can take place at this location without these image indications and/or images having to be forwarded to a server or to a transmission unit. It is rather possible to delete the image indications and/or images directly after their processing and only to supply the data extracted from the image indications and/or images (occupation status of at least the free parking space areas with the associated geographic coordinates and the associated calculated size values) for a further processing in a server and/or a transmission unit. This variant in accordance with the invention is in particular advantageous under technical data protection aspects since no image indications and/or images have to be stored or transmitted over data networks which e.g. include shots of persons or license plates. Such image indications and/or images are rather deleted again directly after the extraction of the data required in accordance with the invention has taken place on site, that is at the location of the camera. This preferred method can also be used when a plurality of cameras with respective recognition units associated with them are used which each provide the data extracted from the image indications to a common server.

The above-described invention can be combined with all those method variants which are descried in the German patent applications 10 2012 005 537.0 and 10 2012 005 575.7. The contents of these two patent applications are herewith also declared part of the content of this patent application. All the features and embodiments described in these two patent applications with respect to parking spaces can equally be applied to parking space areas in accordance with the present application. The principles for the payment of parking spaces described in the named patent applications can in particular also be used in combination with the present invention.

Preferred embodiments of the method in accordance with the invention are described in claims 2 to 5.

Within the framework of a method in accordance with claim 2, any desired image processing methods known from the prior art can inter alia be used for recognizing vehicles such as traffic monitoring systems, the computer-assisted control of vehicles in road traffic or the automatic vehicle recognition within the framework of military applications.

The method in accordance with claim 3 describes a particularly simple manner of association of an occupation status to a parking space area. This method can preferably be used to associate only the occupation status to a parking space area; more complex algorithms are necessary to determine the size values of free parking space areas.

It is particularly preferred if, in accordance with claim 4, a server comprises the transmission unit form transmitting the data to the display unit

a mobile or stationary display unit transmits a query with a geographic destination position to a reception unit integrated in the server and the transmission unit transmits those data to the mobile display unit which describe the current occupation status and the size values of at least the free parking space areas in the ambit of the geographic destination position, with the destination position in particular being the current geographic position of the mobile display unit or the geographic position of a user destination. It becomes possible in this case to display to the respective user only those free parking space areas on hits display unit which are located in the vicinity of the destination position and which have a sufficient size for his vehicle, whereby the display becomes clearer.

In a particularly preferred embodiment of the invention, a user searching for a parking space can select a parking space area desired by him from among the parking space areas displayed to him via his display unit (e.g. smartphone) which in this case also has an input option and can reserve it for himself by the transmission of a selection code associated with the parking space area and by the transmission of a user code identifying the user to a server. The reception of the selection code associated with the reserved parking space area and of the user code by the server then has the consequence that the parking space area reserved by the user is no longer displayed as free to other users of the system in accordance with the invention, which considerably increases the probability that the reserved parking space area is actually also still free when the reserving user reaches it. When the reserved parking space area is reached by the user, the camera detects the vehicle of the user in the parking space area, whereupon the status of this parking space area is changed from “reserved” to “occupied” on the server. If the server should determine after evaluating the image indications of the reserved parking space area that this parking space area has not yet been occupied within a sensible time duration after the reservation, the reservation status of this parking space area is cancelled again so that it is again displayed as free to other users. The named sensible time duration can preferably be calculated in dependence on the distance between the reserved parking space area and the location of the user at the time of the reservation such that it substantially corresponds to the expected travel time between these two points. The procedure of the reservation can also be coupled with an online payment process so that a reservation can only take place against payment of a fee. The level of the reservation fee can be dependent on the time for which the reservation should be active. This embodiment can also be used when the recognition unit only determines the respective occupation status of at least the free parking space areas with the associated geographic coordinates and provides them to the transmission unit, but not the dimensions of a free parking space area.

In another preferred embodiment of the invention, no direct reservation by a user takes place. A user instead transmits, in particular via his display unit, his current location and a user code identifying him to a server which identifies him as user X searching for a parking space. In this case, the user then makes sure that the correspondingly identified user X only has that free parking space area displayed on his display unit which is closest to his vehicle or which can be reached the fastest for him, in particular while taking account of the current traffic situation known to the server. This free parking space area, with which the status “only display to user X” is associated by the server, is then masked out for other users Yₙ at the instigation of the server such that a driving to a free parking space area by a plurality of users simultaneously is avoided. When the parking space area is reached by user X, the camera detects the vehicle of user X in the parking space area, whereupon the status of this parking space area is changed from “only display to user X” to “occupied” on the server. If the server should determine after evaluating the image indications of the named free parking space area that this parking space area has not yet been occupied within a sensible time duration after the status “only display to user X” was associated with it, the status “free” is again associated with the parking space area. This embodiment can likewise also be used when the recognition unit only determines the respective occupation status of at least the free parking space areas with the associated geographic coordinates and provides them to the transmission unit, but not the dimensions of a free parking space area.

It is particularly preferred if the length and/or the width of a user vehicle is stored in the display unit or on a server, and if only those parking space areas are displayed as free in the display unit associated with the user whose size value is larger by a predetermined percentage than the stored length and/or width of his user vehicle. In this manner, the user only has such parking spaces signaled as “free” which are also large enough or his vehicle. As a rule, in this respect, the length and/or the width of the user vehicle is stored in the display unit or on the server. If the user has a vehicle of a much smaller length (e.g. a Smart), which can park transversely to the direction of the street, it can be particularly sensible to store its width.

The method in accordance with the invention can be combined with a fully automatic payment system. The display unit of the user can transmit its GPS coordinates to a server—while it is in the parking space area occupied by the user. The server is thus aware of which parking space area has been occupied by which user so that it can transmit a corresponding debit order to a payment system. It is preferred if the camera detects the vehicle of the user at the GPS coordinates communicated to the server and how long the parking space area was used can thus be monitored. In this case, a payment can take place fully automatically in dependence on the actual length of use of the parking space area.

The invention additionally also comprises at least one camera, a recognition unit, a transmission unit and a display unit as well as a data carrier with a computer program which can be executed on a recognition unit in accordance with the invention. Finally, the invention also comprises a recognition unit which can be used in accordance with the invention.

It is helpful so that the camera can provide image indications which can be evaluated to illuminate the parking space area to be monitored sufficiently, which can be effected using suitable lighting devices, in particular street lamps. It is preferred if the luminous intensity of such a lighting device is controlled in dependence on the brightness values or contrast values determined by the camera. In this manner, on the one hand, an unnecessarily high luminous intensity or an unnecessary energy consumption is avoided with a sufficient brightness or a sufficient contrast; on the other hand, it can be ensured that the luminous intensity is so strong at every time of day and night that usable image indications can be determined.

The above-described aspects of the invention can be combined with one another as desired. Further preferred embodiments of the invention are described in the claims.

The basic principle in accordance with the invention will be explained in the following with reference to the only Figure which shows a schematic representation of components which can be used in accordance with the invention.

A total of three swivel and twist head cameras 10, 12, 14 are provided in the region of a street, with the two swivel and twist head cameras 10, 14 each being equipped with a network transmitter 16. The units of swivel and twist head cameras 10, 14 and network transmitters 16 are suitable to transmit the images taken by the swivel and twist head cameras 10, 14 to a network receiver 18 which is coupled to the swivel and twist head camera 12.

A recognition unit 20 in accordance with the invention is further connected to the swivel and twist head camera 12 and the geographic coordinates of the parking spaces located in the visual range of the swivel and tilt head cameras 10, 12, 14 are stored in it. The recognition unit 20 is configured to associated a respective occupation status, which marks whether a respective parking space is free or occupied, with the named parking spaces in dependence on the images delivered by the swivel and twist head cameras 10, 12, 14. The recognition unit 20 furthermore determines the dimensions of the free parking space areas detected by the swivel and twist head cameras 10, 12, 14, at least in their longitudinal direction, but preferably also in their transverse direction, from the named images.

The recognition unit 20 provides the respective occupation status with the associated geographic coordinates and dimensions of a parking space or of the parking spaces to a transmission unit 22 which is coupled with the recognition unit 20. The images evaluated in the named manner and delivered by the swivel and twist head cameras 10, 12, 14 are subsequently deleted again in the swivel and twist head cameras 10, 12, 14 and in the recognition unit 20, which is of great relevance for aspects of data protection.

The transmission unit 22 transmits the data extracted from the images deleted again in the meantime (occupation status, geographic coordinates, dimensions) to a reception unit 24 of a central server 26.

Further combinations—not shown—of swivel and tilt head cameras, network transmitters, network receivers, recognition unit and transmission unit are provided in further streets and likewise transmit corresponding data to the reception unit 24 of the central server 26.

The server 26 has a transmission/reception unit 28 via which it can transmit the occupation status of the parking spaces, including the associated geographic coordinates and dimensions, detected by the swivel and twist head cameras 10, 12. 14 to a plurality of display units 30. These display units 30 are configured, for example, as internet-enabled mobile end devices on which it is possible to display to a respective user the geographic position in his vicinity at which free parking spaces sufficiently large for his vehicle are just free.

The display units 30 are suitable for sending user queries to the transmission/reception unit 28 of the server 26 to be able, for example, to communicate to the server 26 for which geographic region parking space data should be transmitted to the respective display unit 30.

The invention is not restricted to the above-described embodiment; any desired combinations are rather conceivable here within the framework of the complete above description and the claims.

### REFERENCE NUMERAL LIST

10, 12, 14 swivel and tilt head cameras
16 network transmitter
18 network receiver
20 recognition unit
22 transmission unit
24 reception unit
26 server
28 transmission/reception unit
30 display units

1. A method for displaying free parking space areas on a display unit, in which at least one camera delivers image indications of parking space areas, wherein
geographic coordinates of a parking space zone located in a visual range of the at least one camera are stored in a recognition unit;
the recognition unit associates a respective occupation status with parking space areas disposed within the parking space zone in dependence on the image indications, said occupation status marking whether a respective parking space area is free or occupied;
the recognition unit provides the respective occupation status of at least the free parking space areas with the associated geographic coordinates to a transmission unit; and
the transmission unit transmits the respective occupation status of at least the free parking space areas with the associated geographic coordinates to the display unit; and
the display unit of a user has an input via which a desired parking space area can be selected, whereupon a selection code associated with the selected parking space area is transmitted to a server, whereupon in turn a parking space area reserved in this manner is no longer displayed as free on the display units of other users.

2-9. (canceled)

10. The method in accordance with claim 1, wherein in addition to displaying free parking space areas also occupied parking space areas are displayed.

11. The method in accordance with claim 1, wherein a plurality of cameras deliver image indications of parking space areas.

12. The method in accordance with claim 1, in which
the recognition unit furthermore calculates dimensions of a free parking space area, at least in a longitudinal direction thereof, from the delivered image indications;
the recognition unit furthermore provides the dimensions to the transmission unit; and
the transmission unit furthermore transmits the dimensions to the display device.

13. The method in accordance with claim 12, in which
the recognition unit determines parameters from the image indications using an image processing method, wherein a determination is made on the basis of the determined parameters whether a respective parking space area is occupied and how large the dimensions of a free parking space are in its longitudinal direction and/or in a transverse direction thereof in order then to associate the corresponding occupation status, and for the case that the respective occupation status is “free”, also one or more dimensions, with the parking space area.

14. The method in accordance with claim 12, in which
the server comprises the transmission unit for transmitting data to the display unit; and
a mobile or stationary display unit transmits a query with a geographic destination position to a reception unit integrated in the server; and
the transmission unit of the server transmits those data to the mobile display unit which describe the current occupation status and the dimensions of at least the free parking spaces in the ambit of the geographic destination position.

15. The method in accordance with claim 14, wherein the geographic destination position is a current geographic position of the mobile display unit or a geographic position of a user destination.

16. The method in accordance with claim 1, in which a length and/or a width of a user vehicle is stored in the display unit or on the server; only those parking space areas are displayed as free in the display unit associated with the user whose dimension or dimensions is/are larger by a predetermined percentage than the stored length and/or width of his user vehicle.

17. The method in accordance with claim 1, in which a luminous intensity of a lighting device for illuminating the parking space zone is controlled in dependence on brightness values or contrast values determined by the at least one camera.

18. A method for displaying free parking space areas on a display unit, in which at least one camera delivers image indications of parking space areas, wherein
geographic coordinates of a parking space zone located in a visual range of the at least one camera are stored in a recognition unit;
the recognition unit associates a respective occupation status with parking space areas disposed within the parking space zone in dependence on the image indications, said occupation status marking whether a respective parking space area is free or occupied;
the recognition unit provides the respective occupation status of at least the free parking space areas with the associated geographic coordinates to a transmission unit; and
the transmission unit transmits the respective occupation status of at least the free parking space areas with the associated geographic coordinates to the display unit;
a current location of a user X and an identification code of this user X are transmitted to a server;
the server triggers a display of only that free parking space area on the display unit of user X which is closest to the location of user X or which can be reached the fastest for user X while taking account of the current traffic situation known to the server;
the server associates the status “only display to user X” with this free parking space area; and
the server instigates a masking out of this free parking space area on the display units of other users Yₙ.

19. The method in accordance with claim 18, wherein in addition to displaying free parking space areas also occupied parking space areas are displayed.

20. The method in accordance with claim 18, wherein a plurality of cameras deliver image indications of parking space areas.

21. The method in accordance with claim 18, in which
the recognition unit furthermore calculates dimensions of a free parking space area, at least in a longitudinal direction thereof, from the delivered image indications;
the recognition unit furthermore provides the dimensions to the transmission unit; and
the transmission unit furthermore transmits the dimensions to the display device.

22. The method in accordance with claim 21, in which the recognition unit determines parameters from the image indications using an image processing method, wherein a determination is made on the basis of the determined parameters whether a respective parking space area is occupied and how large the dimensions of a free parking space are in its longitudinal direction and/or in a transverse direction thereof in order then to associate the corresponding occupation status, and for the case that the respective occupation status is “free”, also one or more dimensions, with the parking space area.

23. The method in accordance with claim 21, in which
the server comprises the transmission unit for transmitting data to the display unit; and
a mobile or stationary display unit transmits a query with a geographic destination position to a reception unit integrated in the server; and
the transmission unit of the server transmits those data to the mobile display unit which describe the current occupation status and the dimensions of at least the free parking spaces in the ambit of the geographic destination position.

24. The method in accordance with claim 23, wherein the geographic destination position is a current geographic position of the mobile display unit or a geographic position of a user destination.

25. The method in accordance with claim 18, in which a length and/or a width of a user vehicle is stored in the display unit or on the server; only those parking space areas are displayed as free in the display unit associated with the user whose dimension or dimensions is/are larger by a predetermined percentage than the stored length and/or width of his user vehicle.

26. The method in accordance with claim 18, in which a luminous intensity of a lighting device for illuminating the parking space zone is controlled in dependence on brightness values or contrast values determined by the at least one camera.

27. A system of at least one camera, of a recognition unit, of a transmission unit, and of a display unit, wherein the system is configured to carry out a method for displaying free parking space areas on a display unit, in which at least one camera delivers image indications of parking space areas, wherein
geographic coordinates of a parking space zone located in a visual range of the at least one camera are stored in a recognition unit;
the recognition unit associates a respective occupation status with parking space areas disposed within the parking space zone in dependence on the image indications, said occupation status marking whether a respective parking space area is free or occupied;
the recognition unit provides the respective occupation status of at least the free parking space areas with the associated geographic coordinates to a transmission unit; and
the transmission unit transmits the respective occupation status of at least the free parking space areas with the associated geographic coordinates to the display unit;
in which method either
the display unit of a user has an input via which a desired parking space area can be selected, whereupon a selection code associated with the selected desired parking space area is transmitted to a server, whereupon in turn a parking space area reserved in this manner is no longer displayed as free on display units of other users, wherein a reservation status of the reserved parking space area is cancelled if the reserved parking space area has not been occupied within a predefined time duration after generation of the reservation status; or
a current location of a user X and an identification code of this user X are transmitted to a server;
the server triggers a display of only that free parking space area on the display unit of user X which is closest to the location of user X or which can be reached the fastest for user X while taking account of the current traffic situation known to the server;
the server associates the status “only display to user X” with this free parking space area; and
the server instigates a masking out of this free parking space area on the display units of other users Yₙ.

28. A data carrier with a computer program which executes the steps in accordance with a method for displaying free parking space areas on a display unit, in which at least one camera delivers image indications of parking space areas, wherein
geographic coordinates of a parking space zone located in a visual range of the at least one camera are stored in a recognition unit;
the recognition unit associates a respective occupation status with parking space areas disposed within the parking space zone in dependence on the image indications, said occupation status marking whether a respective parking space area is free or occupied;
the recognition unit provides the respective occupation status of at least the free parking space areas with the associated geographic coordinates to a transmission unit; and
the transmission unit transmits the respective occupation status of at least the free parking space areas with the associated geographic coordinates to the display unit;
in which method either
the display unit of a user has an input via which a desired parking space area can be selected, whereupon a selection code associated with the selected desired parking space area is transmitted to a server, whereupon in turn a parking space area reserved in this manner is no longer displayed as free on display units of other users; or
a current location of a user X and an identification code of this user X are transmitted to a server;
the server triggers a display of only that free parking space area on the display unit of user X which is closest to the location of user X or which can be reached the fastest for user X while taking account of the current traffic situation known to the server;
the server associates the status “only display to user X” with this free parking space area; and
the server instigates a masking out of this free parking space area on the display units of other users Yₙ;
on execution on a computer.
